(19) United States
(12) Patent Application Publication
(10) Pub. No.: US 2005/0121817 A1
(43) Pub. Date: Jun. 9, 2005

(54) Process for mixing polymer melts with additives

(76) Inventors: Thomas Konig, Leverkusen (DE); Klemens Kohlgruber, Kurten (DE); Christian Kords, Krefeld (DE); Stefaan De Vos, Rayong (TH)

Correspondence Address: BAYER MATERIAL SCIENCE LLC, 100 BAYER ROAD, PITTSBURGH, PA, 15205, US

(21) Appl. No.: 11/000,759

(22) Filed: Dec. 1, 2004

(30) Foreign Application Priority Data
Dec. 5, 2003 (DE) 10356821.2

(51) Int. Cl. B29C 47/60; B29C 47/76

(52) U.S. Cl. 264/101; 264/211; 264/102; 264/211.23

(57) ABSTRACT

A continuous process for the preparation of a thermoplastic molding composition is disclosed. Accordingly a first stream containing a molten polymer and at least one additive is introduced into a second extruded stream that contains a molten polymer to produce a combined stream. The temperature of the first stream that is below that of the second stream. The additive is in either liquid form, in solution or in dispersion.

### FIELD OF THE INVENTION

The present invention relates to thermoplastics and more particularly to a process for preparing thermoplastic molding compositions.

### TECHNICAL BACKGROUND OF THE INVENTION

The reasons why thermoplastic polymers are provided with additives prior to processing into end products are very varied. The purpose of incorporating additives is for example to extend the service life of the consumer articles produced from the polycarbonate or to improve color (stabilizers), to simplify processing (e.g. mold release agents, flow auxiliaries, antistatic agents) or to adapt polymer properties to certain stresses (impact modifiers, such as rubbers; flame retardants, colorants, glass fibers).

Mixing polymer streams with apparatus with or without moving parts is familiar to the person skilled in the art. An overview of machinery and apparatus used for this purpose is found for example in “Kunststoff-Extrusionstechnik I-Grundlagen” by Hensen, Knappe and Potente, Hanser Verlag, 1989, ISBN 3-446-14339-4, pages 369 to 375. Types of machines listed therein with which such mixing may be performed are single screw extruders, pin-type extruders, cokneaders, planetary gear or transfermix extruders and multi-screw extruders. Multi-screw extruders may co-rotate or counter-rotate, be intermeshing, be arranged at a tangent to one another or at a large distance from one another. Twin-screw extruders are the most common.

For mixing tasks with machinery with moving parts, special elements are conventionally used as are listed for single- and twin-screw machines in “Kunststoff-Extrusionstechnik I-Grundlagen” by Hensen, Knappe and Potente, Hanser Verlag, 1989, ISBN 3-446-14339-4, page 370, FIG. 10. Examples are knurled elements for single screws and kneading disks for tightly intermeshing twin-screw extruder. These elements may ensure good additive distribution, but have the disadvantage of additional energy input, which may lead to an increase in temperature and thus impairment of product quality, since additives are known to undergo undesired reactions at high temperature. This may happen both by reaction with the polymer matrix or other additives and without further reaction partners, for example by decomposition or rearrangement processes. Such reactions on the one hand reduce the quantity of additives added, so limiting their action. On the other hand, derived products of the reactions may also have a disadvantageous effect on the quality of the polymer, for example by impairing color. In this respect, a long residence time at high temperature has a particularly detrimental effect.

In addition, account should also be taken of the fact that the polymer stream may already be in a machine, such as for example a single- or twin-screw extruder, preferably a twin-screw extruder, in which process steps are already being performed with the material. These may preferably be steps such as reducing the content of volatile constituents by degassing. Downstream of mixing is a step involving discharge from the machine. This discharge requires a certain build up of pressure, for example, for passage through a die plate. It is known that single- and twin-screw extruders have poor pumping efficiency with regard to pressure build-up, such that the energy input leads to an increase in the temperature in the product, and the resultant damage to the product is problematic.

In principle, mixing elements without moving parts, co-called static mixers, may also be used to mix in additives. An example of the use of static mixers is described in “Chemische Industrie”, 37(7), pages 474-476. The use of static mixers is unfavourable however, since, as a member connected downstream of a machine, if they are still to have an industrially acceptable pressure drop, they have residence times which degrade the product. Their pressure drop must either be applied by the upstream extruder, which is associated with low efficiency and thus a temperature increase and product damage, or by an additional assembly for pressure build-up, for example a gear pump, which is associated with additional costs and additional residence time and thus product damage.

DE 40 39 857 A1 describes a further process for mixing additives into a polymer stream, wherein polyamide and polyester melts are preferred. In this process, a side stream is extracted from a main stream, the additives are mixed with the side stream by means of a melt-fed extruder and mixed with the main stream again by means of a static mixer. A disadvantage of this process is the increase, unavoidable in the extruder, in the temperature of part of the main stream, which may on the one hand reduce the quality of the polymer and on the other hand allow undesired secondary reactions of the additive components with one another or with the polymer of the secondary or main stream.

DE 198 41 376 A1 describes a further process for mixing additives into polymers, wherein the examples are directed towards polyester and copolyester. Here too, a side stream is extracted from the main stream, this time by means of a planetary gear pump. The additives are mixed with the side stream by means of a static mixer and the side stream is afterwards remixed with the main stream by means of a static mixer. In this process, it is not possible to incorporate second-quality products into the main stream. The temperature is also set at that of the main stream, such that harmful reactions of the additives may occur at this temperature.

EP 0 905 184 A2 states that extruders, Banbury mixers, roll mills or kneaders may be used to mix additives into polycarbonate melt. The performance of other operations on the same apparatus is not described. All this apparatus has the disadvantage that it may damage the polymer and the additives by energy input and associated temperature increase. Handling of thermoplastic melts on a roll mill is only suitable for laboratory use.

A process is described in U.S. Pat. No. 5,972,273 in which a polycarbonate from the melting process is introduced into an extruder in liquid form, optionally degassed therein and mixed with a mixture of polycarbonate and additives. This mixture is either added as a solids mixture or via an ancillary extruder in molten form.

Process temperatures and details of the screw configuration are not given. The use of second-quality products is not examined. The addition of solid polycarbonate has disadvantages, since this material has first of all to be melted, before a homogeneous mixture is produced. For this purpose, melting elements known to the person skilled in the art, such as for example kneading blocks or barrier zones, are required which increase the temperature of the main stream and thus reduce the quality of the polycarbonate.

The following applications and publications also belong to the prior art:

The screws of tightly intermeshing co-rotating twin-screw extruders can have one or several lobes. Today, two-lobe systems are used commercially, although three-lobe systems are still use. The geometry of the screws of tightly intermeshing co-rotating twin screw extruders is known to those skilled in the art of polymers and has been discussed extensively, for example, in “Geometry of Fully-Wiped Twin-Screw Equipment”, Polymer Engineering and Science, September, 1978, Vol. 18, No. 12. It is usual for tightly intermeshing co-rotating twin-screw extruders to have one screw diameter throughout the machine.

DE 199 14 143 A1 describes an apparatus for degassing plastics, in particular high molecular weight polycarbonate solutions, which consists of a co-rotating tighly intermeshing twin-screw extruder. This provides a possibility of adding additives via an ancillary extruder upstream of the pressure build-up zone.

DE 199 47 630 A1 describes a process for continuous production of a thermoplastic polymer blend and use thereof. In this process, a stream is extracted directly from primary production and mixed in a mixer preferably a static mixer with a side stream of a different polymer, which may contain additives to produce a polymer blend.

DE 100 50 023 A1 describes a mixing apparatus and a process for the production of melt-processable molding compositions, especially additive batches, using two screw machines. The connection of the two screw machines is cooled.

“Plastverarbeiter”, 11(43), 1992, “Statisches Mischen in der Kunststoffverarbeitung und-herstellung”, gives an overview of the mixing operations which are performed with static mixers, examining in particular the various possible uses for the model SMX static mixer, these uses also including the incorporation of low-viscosity additives into polymer melts. The single product example stated therein is the incorporation of mineral oil into polystyrene.

The mixing of additives into polymers may take place in principle with the above-stated machinery, apparatus and processes if the stated disadvantages are accepted.

The object of the present invention was to find a process for mixing with additives a main stream of polymer, preferably polycarbonate, located in a machine, which process eliminates the disadvantages of the prior art and allows the temperature to which the additives are exposed to be minimised.

Furthermore, it should allow the use of so-called second-quality products:

It is known that there is a wide range of specifications for thermoplastic molding compositions with which the person skilled in the art is familiar. This may for example be number- or weight-average molecular weights, chemical composition, degree or order of branching, contents of volatile or extractable substances, degree of crosslinking of elastomeric phases, viscosities at different shear rates, melt flow index, contents of additives, contents of terminal groups of molecules, content of infusible and/or discolored particles, odor, color or form of the product after formulation. The reasons why these specifications may not be met are likewise manifold. It may for example be a result of variations in the quality of the starting material or of a very wide range of disruptions to the process. A further reason for a product failure to meet specifications may lie in start-up procedures or in the need to depart from the specification when changing throughput or product types. This product which does not comply with specifications is here designated second-quality product. Second-quality products may only be sold commercially at reduced prices or have to be disposed of, which causes high costs and results in environmental impact due to unnecessary consumption of resources. It is therefore desirable to find a process with which these second-quality products may be used economically.

The use of second-quality products is neither disclosed nor suggested in the prior art in connection with the mixing of polymers with additives.

### SUMMARY OF THE INVENTION

A continuous process for the preparation of a thermoplastic molding composition is disclosed. Accordingly a first stream containing a molten polymer and at least one additive is introduced into a second extruded stream that contains a molten polymer to produce a combined stream. The temperature of the first stream that is below that of the second stream. The additive is in either liquid form, in solution or in dispersion.

### DETAILED DESCRIPTION OF THE INVENTION

The present invention is directed to a continuous process comprising introducing a first stream containing molten polymer and at least one additive into a second extruded stream of molten polymer to produce a combined stream of polymeric composition in an extruder. The temperature of the first stream is required to be below that of the second stream and the additive is required to be in either liquid form, in solution or in dispersion. In a preferred embodiment the second stream is subject to devolatilization prior to the introduction thereto of the first stream, the devolatilization bringing the content of residual volatiles to less than 1000 ppm, preferably less than 500 ppm. In a yet additional preferred embodiment the first stream is introduced into the second stream at the pressure build-up zone (the term “pressure build up zone” refers to that zone in the extruder where pressure is being generated). In a further preferred embodiment the temperature of the first stream is at least 20+ K, particularly preferably 40° K, lower than that of the second stream. The maximum of difference of temperature is usually 150 K, preferably 100 K. In a yet further embodiment the pressure build-up zone is cooled, such that the temperature at the inside wall of the extruder at the pressure build up zone is at least 40° K , preferably 80+ K most preferably 150° K lower than the temperature of the combined stream. The maximum of the difference of temperature in the pressure build-up zone is usually 200 K, preferably 150 K.

Preferred, particularly preferred or very particularly preferred embodiments are those which make use of parameters, compounds, definitions and explanations which are stated to be preferred, particularly preferred or very particularly preferred, preferential etc.

The definitions, parameters, compounds and explanations stated in the description or in preferential ranges may, however, also be combined together at will, i.e. between the particular ranges and preferential ranges.

The process is particularly well suited to being performed directly after degassing in the same machine. Degassing of polycarbonate is described for example in DE 199 14 143 A1 in which residual volatiles are removed from the polycarbonate (the so-called main stream) in a twin-screw extruder. In order to arrive at a commercial product, additives have to be mixed with the polycarbonate. According to the invention, for this purpose this main stream is mixed with a side stream in melt form, which consists of a mixture of polycarbonate with additives. In principle, therefore, a main stream of polymer present in melt form, which has been devolatilized in an extruder, is mixed in that extruder with a side stream of additives and molten resin, wherein this side stream has a lower temperature than the main stream. This method surprisingly suppresses undesired secondary reactions of additives and polymer and thus results in products which have very good inherent color and excellent properties.

Furthermore, this process surprisingly allows economic reutilisation of second-quality products not complying with specifications, since the product obtained overall has good quality and complies with the specifications.

It has additionally been found that it is particularly favourable for the quality of the final product, if this side stream is colder than the main stream, preferably by 20° K, particularly preferably by 40° K. It has also surprisingly been found that cooling of the pressure build-up zone has a favourable effect on the quality of the final product.

The process is particularly favourable when using a single- or twin-screw extruder.

Degassing is preferably performed beforehand on the machine.

It is preferred for the side stream to be produced from molten polymer material. It has surprisingly been found that a mixture of saleable quality is obtained even if second-quality product or recycled polycarbonate material is used in the side stream.

The additives are preferably fed partially or wholly to the melting member for the side stream.

It has likewise surprisingly been found that it is possible to dispense with the use of special kneading or mixing elements for incorporating the side stream. It has been found that the mixing action of the pressure build-up zone is good enough to produce a product which complies with specifications. The additional increase in temperature and associated reduction in quality caused by the additional energy input may thus be prevented.

Suitable equipment for carrying out the inventive process may be designed by a person skilled in the art according to the prior art and may for example include a single-screw extruder, a co-rotating or counter rotating twin-screw extruder, a multiscrew extruder rotating in the same direction or a co-kneader. Preferably, a co-rotating twin-screw extruder or a counter-rotating twin-screw extruder is used. However, in principle all apparatus and assemblies known for this purpose, as described in the prior art, for example in “Plastverarbeiter”, 11(43), 1992, “Statisches Mischen in der Kunststoffverarbeitung und -herstellung”; “Kunststoff-Extrusionstechnik I-Grundlagen” by Hensen, Knappe und Potente, Hanser Verlag, 1989, ISBN 3-446-14339-4, page 370, FIG. 10, DE 40 39 857 A1, DE 198 41 376 A1 or U.S. Pat. No. 5,972,273.

The weight ratio of the side stream to the main stream amounts preferably to 1:4 to 1:30, particularly preferably 1:5 to 1:20.

Possible polymers for the above-stated operations are in principle all thermoplastics and mixtures thereof, for example polystyrene, copolymers of styrene and acrylonitrile, styrene and methyl methacrylate, styrene and methyl methacrylate and acrylonitrile, α-methylstyrene and acrylonitrile, styrene and α-methylstyrene and acrylonitrile, styrene and n-phenylmaleimide and styrene and n-phenylmaleimide and acrylonitrile, polyethylene, chlorinated polyethylene, copolymers of ethylene and vinyl acetate, polyethylene and alpha-olefins such as butene, hexene, octene, polypropylene, chlorinated polypropylene, polyetherether ketone, polyoxymethylene, polycarbonate, preferably polycarbonates, polyesters, polyamides and copolymers containing acrylonitrile and mixtures thereof, particularly preferably polycarbonate and mixtures containing polycarbonate, very particularly preferably polycarbonate, for example obtained using the phase boundary process or the melt transesterification process.

Preferred machines for performing the preceding processing operation are single-, twin- or multi-screw extruders. Tightly intermeshing, co-rotating twin-screw extruders are particularly preferred, especially in a two-lobe configuration.

A preferred pressure build-up zone for a tightly intermeshing twin screw extruder is in a three-lobe configuration with smaller screw diameter than the two-lobe configuration.

A process is also preferred which is characterised in that the side stream is formed of molten polycarbonate granular product and/or polycarbonate fragments, in particular of recycled polycarbonate material.

A process is likewise preferred which is characterised in that some of the additives or all the additives are fed to the melting member for the side stream.

A process is likewise preferred which is characterised in that the pressure build-up operation is combined with that of mixing, without special mixing or kneading elements being used therefore.

A particularly preferred embodiment of the machine is a co-rotating, tightly intermeshing twin-screw extruder or a counter-rotating twin-screw extruder.

An especially preferred process is characterized in that the embodiment of the machine is a tightly intermeshing twin-screw extruder with a three-lobe pressure build-up zone.

The process is applicable in particular to polymers and polymer blends, in which the blend exhibits a viscosity in the range from 1 Pa.s to 10⁷ Pa.s.

The invention further provides thermoplastic molding compositions obtainable using the process according to the invention.

Additives may impart a wide range of properties to a polymer and may comprise for example antioxidants, UV absorbers and light stabilizers, metal deactivators, peroxide scavengers, basic costabilizers, nucleating agents, benzofurans and indolinones active as stabilizers or antioxidants, mold release agents, flame-retarding additives, antistatic agents, colorants and melt stabilizers.

The amount of additives which are metered by the present process is of 0.05 to 15 wt. %, preferably of 0.1 to 15 wt. %, more preferably 0.2 to 8 wt. % and in particular 0.2 to 5 wt. % (referred to the weight of the composition). In case a masterbatch of additive is produced by the present process the additives are metered in an amount of 1 to 15 wt. %, preferably of 3 to 10 wt. % (referred to the weight of the composition). Otherwise the additives are usually metered to the polymer melt in an amount of 0.05 to 1.5, preferably 0.7 to 1 and most preferably 0.1 to 0.5 wt. %.

Preferred, suitable additives are described for example in Additives for Plastics Handbook, John Murphy, 1999 or Plastics Additives Handbook Hans Zweifel, 2001.

Suitable additives which may be used are selected from at least one of the following:

1.1. Preferred, suitable antioxidants are for example:

1.1.1. Alkylated monophenols, for example 2,6-di-tert.-butyl-4-methylphenol, 2-tert.-butyl-4,6-dimethylphenol, 2,6-di-tert.-butyl-4-ethylphenol, 2,6-di-tert.-butyl-4-n-butylphenol, 2,6-di-tert.-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert.-butyl-4-methoxymethylphenol, nonylphenols, which are linear or branched in the side chain, for example, 2,6-di-nonyl-4-methylphenol, 2,4-dimethyl-6-(1′-methylundec-1′-yl)phenol, 2,4-di-methyl-6-(1′-methylheptadec-1′-yl)phenol, 2,4-dimethyl-6-(1′-methyltridec-1′yl)phenol.

1.1.2. Alkylthiomethylphenols, for example 2,4-dioctylthiomethyl-6-tert.-butylphenol, 2,4-di-octylthiomethyl-6-methylphenol, 2,4-dioctylthiomethyl-6-ethylphenol, 2,6-didodecylthiomethyl-4-nonylphenol.

1.1.3. Hydroquinones and alkylated hydroquinones, for example 2,6-di-tert.-butyl-4-methoxy-phenol, 2,5-di-tert.-butylhydroquinone, 2,5-di-tert.-amylhydroquinone, 2,6-diphenyl-4-octadecyl-oxyphenol, 2,6-di-tert.-butylhydroquinone, 2,5-di-tert.-butyl-4-hydroxyanisole, 3,5-di-tert.-butyl-4-hydroxyanisole, 3,5-di-tert.-butyl-4-hydroxypheriyl stearate, bis(3,5-di-tert.-butyl-4-hydroxyphenyl)adipate.

1.1.4. Tocopherols, for example α-tocopherol, β-tocopherol, γ-tocopherol, δ-tocopherol and mixtures thereof (vitamin E).

1.1.5. Hydroxylated thiodiphenyl ethers, for example 2,2′-thiobis(6-tert.-butyl-4-methylphenol), 2,2′-thiobis(4-octylphenol), 4,4′-thiobis(6-tert.-butyl-3-methylphenol), 4,4′-thiobis(6-tert.-butyl-2-methylphenol), 4,4′-thiobis(3,6-di-sec.-amylphenol), 4,4′-bis(2,6-dimethyl-4-hydroxyphenyl)disulfide.

1.1.6. Alkylidenebisphenols, for example 2,2′-methylenebis(6-tert.-butyl-4-methylphenol), 2,2′-methylenebis(6-tert.-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert.-butylphenol), 2,2′-ethylidenebis(4,6-di-tert.-butylphenol), 2,2′-ethylidenebis(6-tert. -butyl-4-isobutylphenol), 2,2′-methylenebis[6-(α-methylbenzyl)-4-nonylphenol], 2,2′-methylenebis [6-(α,αdimethylbenzyl)-4-nonylphenol], 4,4′-methylenebis(2,6-di-tert.-butylphenol), 4,4′-methylenebis(6-tert.-butyl-2-methylphenol), 1,1-bis(5-tert.-butyl-4-hydroxy-2-methylphenyl)butane, 2,6-bis(3-tert.-butyl-5-methyl-2-hydroxybenzyl)-4-methylphenol, 1,1,3-tris(5-tert.-butyl-4-hydroxy-2-methylphenyl)butane, 1,1-bis(5-tert.-butyl-4-hydroxy-2-methylphenyl)-3-n-dodecylmercaptobutane, ethylene glycol bis[3,3-bis(3′-tert.-butyl-4′-hydroxyphenyl)butyrate], bis(3-tert.-butyl-4-hydroxy-5-methylphenyl)dicyclopentadiene, bis[2-(3′-tert.-butyl-2′-hydroxy-5′-methylbenzyl)-6-tert.-butyl-4-methylphenyl]terephthalate, 1,1-bis(3,5-dimethyl-2-hydroxyphenyl)butane, 2,2-bis(3,5-di-tert.-butyl-4-hydroxyphenyl)propane, 2,2-bis(5-tert.-butyl-4-hydroxy-2-methylphenyl)-4-n-dodecylmercaptobutane, 1,1,5,5-tetra-(5-tert.-butyl-4-hydroxy-2-methylphenyl)pentane.

1.1.7. O—, N— and S-benzyl compounds, for example 3,5,3′,5′-tetra-tert.-butyl-4,4′-dihydroxy-dibenzyl ether, octadecyl-4-hydroxy-3,5-dimethylbenzyl mercaptoacetate, tridecyl-4-hydroxy-3,5-di-tert.-butylbenzyl mercaptoacetate, tris(3,5-di-tert.-butyl-4-hydroxybenzyl)amine, bis(4-tert.-butyl-3-hydroxy-2,6-dimethylbenzyl)dithioterephthalate, bis(3,5-di-tert.-butyl-4-hydroxybenzyl) sulfide, isooctyl-3,5-di-tert.-butyl-4-hydroxybenzyl mercaptoacetate.

1.1.8. Hydroxybenzylated malonates, for example dioctadecyl-2,2-bis(3,5-di-tert.-butyl-2-hydroxybenzyl)malonate, dioctadecyl-2-(3-tert.-butyl-4-hydroxy-5-methyl-benzyl)malonate, didodecylmercaptoethyl-2,2-bis(3,5-di-tert.-butyl-4-hydroxybenzyl)malonate, bis[4-(1,1,3,3-tetramethylbutyl)phenyl]-2,2-bis(3,5-di-tert.-butyl-4-hydroxybenzyl)malonate.

1.1.9. Aromatic hydroxybenzyl compounds, for example 1,3,5-tris(3,5-di-tert.-butyl-4-hydroxybenzyl)-2,4,6-trimethylbenzene, 1,4-bis(3,5-di-tert.-butyl-4-hydroxybenzyl)-2,3,5,6-tetramethylbenzene, 2,4,6-tris(3,5-di-tert.-butyl-4-hydroxybenzyl)phenol.

1.1.10. Triazine compounds, for example 2,4-bis(octylmercapto)-6-(3,5-di-tert.-butyl-4-hydroxyanilino)-1,3,5-triazine, 2-octylmercapto-4,6-bis(3,5-di-tert.-butyl-4-hydroxyanilino)-1,3,5-triazine, 2-octylmercapto-4,6-bis(3,5-di-tert.-butyl-4-hydroxyphenoxy)-1,3,5-triazine, 2,4,6-tris(3,5-di-tert.-butyl-4-hydroxyphenoxy)-1,2,3-triazine, 1,3,5-tris-(3,5-di-tert.-butyl-4-hydroxybenzyl)isocyanurate, 1,3,5-tris(4-tert.-butyl-3-hydroxy-2,6-dimethylbenzyl)isocyanurate, 2,4,6-tris(3,5-di-tert.-butyl-4-hydroxyphenylethyl)-1,3,5-triazine, 1,3,5-tris(3,5-di-tert.-butyl-4-hydroxyphenylpropionyl)hexahydro-1,3,5-triazine, 1,3,5-tris(3,5-dicyclohexyl-4-hydroxybenzyl)isocyanurate.

1.1.11. Acylaminophenols, for example 4-hydroxylauranilide, 4-hydroxystearanilide, octyl-N-(3,5-di-tert.-butyl-4-hydroxyphenyl)carbamate.

1.1.12. Esters of β-(3,5-di-tert.-butyl-4-hydroxyphenyl)propionic acid with monohydric or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.1.13. Esters of β-(5-tert.-butyl-4-hydroxy-3-methylphenyl)propionic acid with monohydric or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.1.14. Esters of β-(3,5-dicyclohexyl-4-hydroxyphenyl)propionic acid with monohydric or polyhydric alcohols, e.g. with methanol, ethanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.1.15. Esters of 3,5-Di-tert.-butyl-4-hydroxyphenylacetic acid with monohydric or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.1.16. Amides of β-(3,5-di-tert.-butyl-4-hydroxyphenyl)propionic acid, e.g. N,N′-bis(3,5-di-tert.-butyl-4-hydroxyphenylpropionyl)hexamethylenediamide, N,N′-bis(3,5-di-tert.-butyl-4-hydroxy-phenylpropionyl)trimethylenediamide, N,N′-bis(3,5-di-tert.-butyl-4-hydroxyphenylpropionyl)hydrazide, N,N′-bis[2-(3-[3,5-di-tert.-butyl-4-hydroxyphenyl]-propionyloxy)ethyl]oxamide (Naugard® XL-1 made by Uniroyal).

1.1.17. Ascorbic acid (vitamin C)

1.1.18. Amine-type antioxidants, for example N,N′-diisopropyl-p-phenylenediamine, N,N′-di-sec.-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec.-butyl-p-phenylenediamine, diphenylamine, N-allyldiphenylamine, 4-isopropoxydiphenylamine, N-phenyl-1-naphthylamine, N-(4-tert.-octylphenyl)-1-naphthylamine, N-phenyl-2-naphthylamine, octylated diphenylamine, for example p,p′-di-tert.-octyl-diphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert.-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis [4-(1′,3′-dimethylbutyl)phenyl]amine, tert.-octylated N-phenyl-1-naphthylamine, a mixture of mono- and dialkylated tert.-butyl/tert.-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert.-butyldiphenylamines, 2,3-dihydro-3,3-dimethyl-4H-1,4-benzothiazine, phenothiazine, a mixture of mono- and dialkylated tert.-butyl/tert.-octylphenothiazines, a mixture of mono- and dialkylated tert.-octylphenothiazines, N-allylphenothiazine, N,N,N′,N′-tetraphenyl-1,4-diaminobut-2-ene, N,N-bis(2,2,6,6-tetramethylpiperid-4-yl)hexamethylenediamine, bis(2,2,6,6-tetramethylpiperid-4-yl)sebacate, 2,2,6,6-tetramethylpiperidin-4-one, 2,2,6,6-tetramethylpiperidin-4-ol. These compounds may be used individually or as mixtures thereof.

1.1.19. Suitable thiosynergists are preferably for example dilauryl thiodipropionate and/or distearyl thiodipropionate.

1.1.20. Secondary antioxidants, phosphites and phosphonites are for example tris(nonylphenyl)phosphite, tris(2,4-di-tert.-butylphenyl)phosphite, 3,9-bis(2,4-di-tert.-butylphenoxy)-2,4,8,10-tetraoxa-3,9-diphosphaspiro[5.5]undecane, 3,9-bis(2,6-di-tert.-butyl-4-methylphenoxy)-2,4,8,10-tetraoxa-3,9-diphosphaspiro(5.5)undecane, 2,2′-methylenebis(4,6-di-tert.-butylphenyl)octyl phosphite, tetrakis(2,4-di-tert.-butylphenyl)-[1,1-biphenyl]-4,4′-diyl bisphosphonite, 2,2′-ethylidenebis(4,6-di-tert.-butylphenyl)fluorophosphite, o,o′-dioctadecylpentaerythritol bis(phosphite), tris[2-[[2,4,8,1 0-tetra-tert.-butyldibenzo[d,f][1,3,2]dioxaphosphepin-6-yl]oxy]ethyl]amine, bis(2,4-di-tert.-butyl-6-methylphenyl)ethylphosphite, 2-butyl-2-ethyl-1,3-propanediyl-2,4,6-tri-tert.-butylphenyl phosphite, pentaerythritol bis((2,4-dicumylphenyl)-phosphite), 2,4,6-tri-tert.-butylphenyl-2-butyl-2-ethyl-1,3-propanediol phosphite.

1.2. Preferred UV absorbers and light stabilizers used in the present process are for example:

1.2.1. 2-(2′-Hydroxyphenyl)benzotriazoles, for example 2-(2′-hydroxy-5′-methylphenyl)benzotriazole, 2-(3′,5′-di-tert.-butyl-2′-hydroxyphenyl)benzotriazole, 2-(5′-tert.-butyl-2′-hydroxyphenyl)benzotriazole, 2-(2′-hydroxy-5′-(1,1,3,3-tetramethylbutyl)phenyl)benzotriazole, 2-(3′,5′-di-tert.-butyl-2′-hydroxyphenyl)-5-chlorobenzotriazole, 2-(3′-tert.-butyl-2′-hydroxy-5′-methylphenyl)-5-chlorobenzotriazole, 2-(3′-sec.-butyl-5′-tert.-butyl-2′-hydroxyphenyl)benzotriazole, 2-(2′-hydroxy-4′-octyloxyphenyl)benzotriazole, 2-(3′,5′-di-tert.-amyl-2′-hydroxyphenyl)benzotriazole, 2-(3′,5′-bis(α,α-dimethylbenzyl)-2′-hydroxyphenyl)benzotriazole, 2-(3′-tert.-butyl-2′-hydroxy-5′-(2-octyloxycarbonylethyl)phenyl)-5-chlorobenzotriazole, 2-(3′-tert.-butyl-5′-[2-(2-ethylhexyloxy)carbonylethyl]-2′-hydroxyphenyl)-5-chlorobenzotriazole, 2-(3′-tert.-butyl-2′-hydroxy-5′-(2-methoxycarbonylethyl)phenyl)-5-chlorobenzotriazole, 2-(3′-tert.-butyl-2′-hydroxy-5′-(2-methoxycarbonylethyl)phenyl)benzotriazole, 2-(3′-tert.-butyl-2′-hydroxy-5′-(2-octyloxycarbonylethyl)phenyl)benzotriazole, 2-(3′-tert.-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert.-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the transesterification product of 2-[3′-tert.-Butyl-5′-(2-methoxycarbonylethyl)-2′-hydroxyphenyl]-2H-benzotriazole with polyethylene glycol 300; [R—CH₂CH₂-COO—CH₂CH₂]₂, wherein R=3′-tert.-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole.

1.2.2. 2-Hydroxybenzophenones, for example the 4-hydroxy-, 4-methoxy-, 4-octyloxy-, 4-decyloxy-, 4-dodecyloxy-, 4-benzyloxy-, 4,2′,4′-trihydroxy- and 2′-hydroxy-4,4′-dimethoxy derivatives.

1.2.3. Esters of substituted and unsubstituted benzoic acids, such as for example 4-tert.-butylphenyl salicylate, phenyl salicylate, octylphenyl salicylate, dibenzoylresorcinol, bis(4-tert.-butylbenzoyl)resorcinol, benzoylresorcinol, 2,4-di-tert.-butylphenyl-3,5-di-tert.-butyl-4-hydroxybenzoate, hexadecyl-3,5-di-tert.-butyl-4-hydroxybenzoate, octadecyl-3,5-di-tert.-butyl-4-hydroxybenzoate, 2-methyl-4,6-di-tert.-butylphenyl-3,5-di-tert.-butyl-4-hydroxybenzoate.

1.2.4. Acrylates, for example ethyl-α-cyano-β,β-diphenyl acrylate, isooctyl-α-cyano-β,β-diphenyl acrylate, methyl-α-carbomethoxy cinnamate, methyl-α-cyano-β-methyl-p-methoxy cinnamate, butyl-α-cyano-β-methyl-p-methoxy cinnamate, methyl-α-carbomethoxy-β-methoxy cinnamate and N-(β,-carbomethoxy-β-cyanovinyl)-2-methylindoline.

1.2.5. Nickel compounds, for example nickel complexes of 2,2′-thiobis[4-(1,1,3,3-tetramethylbutyl)phenol], such as the 1:1 or 1:2 complex, with or without additional ligands, such as n-butylamine, triethanolamine or N-cyclohex)ldiethanolamine, nickel dibutyl dithiocarbamate, nickel salts of the monoalkyl esters, e.g. the methyl or ethyl ester, of 4-hydroxy-3,5-di-tert.-butylbenzylphosphonic acid, nickel complexes of ketoximes, e.g. of 2-hydroxy-4-methylphenyl-undecyl ketoxime, nickel complexes of 1-phenyl-4-lauroyl-5-hydroxypyrazole, with or without additional ligands.

1.2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl), n-butyl-3,5-di-tert.-butyl-4-hydroxybenzyl malonate, the condensation product of 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyl)hexamethylenediamine and 4-tert.-octylamino-2,6-dichloro-1,3,5-triazine, tris(2,2,6,6-tetramethyl-4-piperidyl)nitrilotriacetate, tetrakis(2,2,6,6-tetramethyl-4-piperidyl) 1,2,3,4-butanetetracarboxylate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert.-butylbenzyl)malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl)succinate, linear or cyclic condensation products of N,N′-bis(2,2,6,6-tetramethyl-4-piperidyl)hexamethylenediamine and 4-morpholino-2,6-dichloro-1,3,5-triazine, the condensation product of 2-chloro-4,6-bis(4-n-butylamino-2,2,6,6-tetramethylpiperidyl)-1,3,5-triazine and 1,2-bis(3-aminopropylamino)ethane, the condensation product of 2-chloro-4,6-bis(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decan-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidin-2,5-dione, a mixture of 4-hexadecyloxy- and 4-stearyloxy-2,2,6,6-tetra-methylpiperidine, a condensation product of N,N′-bis(2,2,6,6-tetramethyl-4-piperidyl)hexamethylendiamine and 4-cyclohexylamino-2,6-dichloro-1,3,5-triazine, a condensation product of 1,2-bis(3-aminopropylamino)ethane and 2,4,6-trichloro-1,3,5-triazine and 4-butylamino-2,2,6,6-tetramethylpiperidine (CAS Reg. No. [136504-96-6]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxospiro[4.5]decane, a reaction product of 7,7,9,9-tetramethyl-2-cycloundecyl-1-oxa-3,8-diaza-4-oxospiro[4.5]decane and epichlorohydrin, 1,1-bis(1,2,2,6,6-pentamethyl-4-piperidyloxycarbonyl)-2-(4-methoxyphenyl)ethene, N,N′-bis(formnyl)-N,N′-bis(2,2,6,6-tetramethyl-4-piperidyl)hexamethylenediamine, diesters of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic anhydride/a-olefin copolymer with 2,2,6,6-tetramethyl-4-aminopiperidine or 1,2,2,6,6-pentamethyl-4-aminopiperidine.

1.2.7. Oxamides, for example 4,4′-dioctyloxyoxanilide, 2,2′-diethoxyoxanilide, 2,2′-dioctyloxy-5,5′-di-tert.-butoxanilide, 2,2′-didodecyloxy-5,5′-di-tert.-butoxanilide, 2-ethoxy-2′-ethyloxanilide, N,N′-bis(3-dimethylaminopropyl)oxamide, 2-ethoxy-5-tert.-butyl-2′-ethoxanilide and a mixture thereof with 2-ethoxy-2′-ethyl-5,4′-di-tert.-butoxanilide, mixtures of o-and p-methoxy-disubstituted oxanilides and mixtures of o- and p-ethoxy-disubstituted oxanilides.

1.2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxy-phenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

These compounds may be used individually or as mixtures thereof.

1.3. Suitable metal deactivators are for example N,N′-diphenyloxamide, N-salicylal-N′-salicyloylhydrazine, N,N′-bis(salicyloyl)hydrazine, N,N′-bis(3,5-di-tert.-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoylbisphenyl hydrazide, N,N′-diacetyl-adipoyl dihydrazide, N,N′-bis(salicyloyl)oxalyl dihydrazide, N,N′-bis(salicyloyl)thiopropionyl dihydrazide. These compounds may be used individually or as mixtures thereof.

1.4. Suitable peroxide scavengers are preferably, for example, esters of β-thiodipropionic acid, for example the lauryl, stearyl, myristyl or tridecyl ester, mercaptobenzimidazole or the zinc salt of 2-mercaptobenzimidazole, zinc dibutyldithiocarbamate, dioctadecyl disulfide, pentaerythritol tetrakis(dodecylmercapto)propionate. These compounds may be used individually or as mixtures thereof.

1.5 Suitable basic costabilizers are preferably, for example melamine, pol),vinylpyrrolidone, dicyandiamide, triallylcyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate. These compounds may be used individually or as mixtures thereof.

1.6 Suitable nucleating agents which are preferred, for example as a crystal nucleus for crystalline thermoplastics and as a nucleus for bubble formation in foam applications, are for example inorganic substances, such as talcum, metal oxides, such as titanium dioxide or magnesium oxide, phosphates, carbonates or sulfates, preferably of alkaline earth metals; organic compounds, such as mono- or polycarboxylic acids and salts thereof, e.g. 4-tert.-butylbenzoic acid, adipic acid, diphenylacetic acid, sodium succinate or sodium benzoate; polymeric compounds, such as ionic copolymers (ionomers). 1,3:2,4-Bis(3′,4′-dimethylbenzylidene)sorbitol, 1,3:2,4-di(paramethyldibenzylidene)sorbitol and 1,3:2,4-di(benzylidene)sorbitol are particularly preferred. These compounds may be used individually or as mixtures thereof.

1.7 Other additives which are preferably suitable are, for example, plasticizers, slip agents, emulsifiers, pigments, viscosity modifiers, catalysts, levelling agents, optical brighteners, flame retardants, antistatic agents and blowing agents.

1.8 Suitable benzofuranones and indolinones which are preferred are for example those which are disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-43 16 61 1; DE-A-43 16 622; DE-A-43 16 876; EP-A-0 589 839 or EP-A-0 591 102, or 3-[4-(2-acetoxyethoxy)phenyl]-5,7-di-tert.-butyl-benzofuran-2-one, 5,7-di-tert.-butyl-3-[4-(2-stearoyloxyethoxy)phenyl]benzofuran-2-one, 3,3′-bis [5,7-di-tert.-butyl-3-(4-[2-hydroxyethoxy]phenyl)-benzofuran-2-one], 5,7-di-tert.-butyl-3-(4-ethoxyphenyl)benzofuran-2-one, 3-(4-acetoxy-3,5-dimethylphenyl)-5,7-di-tert.-butylbenzofuran-2-one, 3-(3,5-dimethyl-4-pivaloyloxyphenyl)-5,7-di-tert.-butylbenzofuran-2-one, 3-(3,4-dimethylphenyl)-5,7-di-tert.-butylbenzofuran-2-one, 3-(2,3-dimethylphenyl)-5,7-di-tert.-butylbenzofuran-2-one, lactone antioxidants such as

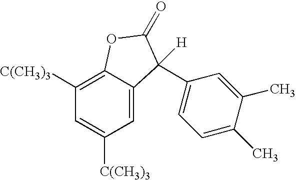

These compounds act for example as antioxidants. These compounds may be used individually or as mixtures thereof.

1.9. Suitable fluorescent plasticizers which are preferred are listed in “Plastics Handbook”, eds. R. Gächter and H. Müller, Hanser Verlag, 3rd ed., 1990, pages 775-789.

1.10. Suitable mold release agents which are preferred are esters of aliphatic acids and alcohols, e.g. pentaerythritol tetrastearate and glycerol monostearate; they are used alone or in a mixture preferably in an amount of 0.02 to 1 wt. %, relative to the weight of the composition.

1.11. Suitable flame retardant additives which are preferred are phosphate esters, i.e. triphenyl phosphate, resorcinol diphosphoric acid esters, bromine-containing compounds, such as brominated phosphoric acid esters, brominated oligocarbonates and polycarbonates, together with salts, such as C₄F₉SO₃⁻Na⁺.

1.12. Suitable antistatic agents which are preferred are sulfonate salts for example tetraethylammonium salts of C₁₂H₂₅SO³⁻ or C₈F₁₇SO³⁻.

1.13. Suitable colorants which are preferred are pigments together with organic and inorganic colorants.

1.14. Compounds containing epoxy groups, such as 3,4-epoxycyclohexylmethyl 3,4-epoxycyclohexylcarboxylate, copolymers of glycidylmethacrylate and epoxysilanes.

1.15. Compounds containing anhydride groups, such as maleic anhydride, succinic anhydride, benzoic anhydride and phthalic anhydride.

The compounds of groups 1.14 and 1.15 act as melt stabilizers. They may be used individually or as mixtures.

Polycarbonates for the purposes of the present invention are both homopolycarbonates and copolycarbonates; the polycarbonates may in known manner be linear or branched.

Some, up to 80 mol %, preferably from 20 mol % to 50 mol %, of the carbonate groups in the polycarbonates suitable according to the invention may be replaced by aromatic dicarboxylic acid ester groups. Such polycarbonates, which contain both acid residues of carbonic acid and acid residues of aromatic dicarboxylic acids incorporated into the molecule chain, are, precisely stated, aromatic polyester carbonates. For simplicity's sake, in the present application they are subsumed under the generic term “thermoplastic, aromatic polycarbonates”.

Production of the polycarbonates to be used in the process according to the invention proceeds in known manner from aromatic dihydroxy compounds, carbonic acid derivatives, optionally chain terminators and optionally branching agents, wherein for production of the polyester carbonates some of the carbonic acid derivatives are replaced by aromatic dicarboxylic acids or derivatives of the dicarboxylic acids, specifically, in accordance with the carbonate structural units to be replaced in the aromatic polycarbonates, by aromatic dicarboxylic acid ester structural units.

Details relating to the production of polycarbonates have been set down in hundreds of patent specifications over the last approx. 40 years. Reference will be made here, merely by way of example, to Schnell, “Chemistry and Physics of Polycarbonates”, Polymer Reviews, Volume 9, Interscience Publishers, New York, London, Sydney 1964;

D. C. Prevorsek, B. T. Debona and Y. Kesten, Corporate Research Center, Allied Chemical Corporation, Morristown, N.J. 07960: “Synthesis of Poly(ester Carbonate) Copolymers” in Journal of Polymer Science, Polymer Chemistry Edition, Vol. 19, 75-90 (1980)”;

D. Freitag, U. Grigo, P. R. Müller, N. Nouvertne', BAYER AG, “Polycarbonates” in Encyclopedia of Polymer Science and Engineering, Volume 11, Second Edition, 1988, pages 648-718 and finally

Dr. U. Grigo, Dr. K. Kircher and Dr. P. R-Müller “Polycarbonate” in Becker/Braun, Kunststoff-Handbuch, Vol. 3/1, “Polycarbonate, Polyacetale, Polyester, Celluloseester”, Carl Hanser Verlag Munich, Vienna, 1992, pages 117-299.

The thermoplastic polycarbonates, which are preferably used in the process, including the thermoplastic, aromatic polyester carbonates, have weight average molecular weights M_{w} (determined by measurement of the relative viscosity at 25° C. in CH₂Cl₂ and a concentration of 0.5 g per 100 ml CH₂Cl₂) of 12,000 to 120,000, preferably of 15,000 to 80,000 and in particular of 15,000 to 60,000.

Aromatic dihydroxy compounds suitable for the production of polycarbonates are for example hydroquinone, resorcinol, dihydroxydiphenyl, bis(hydroxyphenyl)alkanes, bis(hydroxyphenyl)cycloalkanes, bis(hydroxyphenyl)sulfides, bis(hydroxyphenyl)ethers, bis(hydroxyphenyl)ketones, bis(hydroxyphenyl)sulfones, bis(hydroxyphenyl)sulfoxides, α,α-bis(hydroxyphenyl)diisopropylbenzenes, and the ring-alkylated and ring-halogenated compounds thereof.

Preferred aromatic dihydroxy compounds are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,1-bis(4-hydroxyphenyl)-m/p-diisopropylbenzene, 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,1-bis(3,5-dimethyl-4-hydroxyphenyl)-m/p-diisopropylbenzene, 2,2- and 1,1-bis(4-hydroxyphenyl)-3,3,5-trimethylcyclohexane.

Particularly preferred aromatic dihydroxy compounds are 4,4′-dihydroxydiphenyl, 1,1-bis(4-hydroxyphenyl)phenylethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(4-hydroxyphenyl)-m/p-diisopropylbenzene and 1,1-bis(4-hydroxyphenyl)-3,3,5-trimethylcyclohexane.

These and other suitable aromatic dihydroxy compounds are described for example in patent specifications: U.S. Pat. No. 3,028,635, U.S. Pat. No. 2,999,835, U.S. Pat. No. 3,148,172, U.S. Pat. No. 2,991,273, U.S. Pat. No. 3,271,367, U.S. Pat. No. 4,982,014 and U.S. Pat. No. 2,999,846, in German published patent applications DE-A-1 570 703, DE-A-2 063 050, DE-A-2 036 052, DE-A-2 211 956 and DE-A-3 832 396, French patent specification FR1 561 518, in the monograph “H. Schnell, Chemistry and Physics of Polycarbonates, Interscience Publishers, New York 1964” and in Japanese published patent applications 62039/1986, 62040/1986 and 105550/1986.

In the case of homopolycarbonates, only one aromatic dihydroxy compound is used, while in the case of copolycarbonates two or more such compounds are used, wherein the aromatic dihydroxy compounds used, like all the other chemicals and auxiliaries added to the synthesis, may obviously be contaminated with impurities originating from the synthesis thereof, although it is desirable to use the cleanest possible raw materials.

Suitable chain terminators are both monophenols and monocarboxylic acids. Suitable monophenols are phenols, alkylphenols such as cresol, p-tert.-butylphenol, p-n-octylphenol, p-iso-octylphenol, p-n-nonylphenol and p-iso-nonylphenol, halophenols such as p-chlorophenol, 2,4-dichlorophenol, p-bromophenol and 2,4,6-tribromophenol, and the mixtures thereof.

Suitable monocarboxylic acids are benzoic acid, alkylbenzoic acids and halobenzoic acids. Preferred chain terminators are the phenols of the formula (I)
R⁶-Ph-OH (I)
in which R⁶ denotes H or a branched or unbranched C₁-C₁₈ alkyl residue.

The quantity of chain terminator used amounts to 0.5 mol % to 10 mol %, relative to moles of diphenols used in each case. The addition of chain terminators may take place before, during or after phosgenation.

Suitable branching agents are the tri- or more than trifunctional compounds known in polycarbonate chemistry, in particular those with three or more than three phenolic OH groups.

Suitable branching agents are for example phloroglucinol, 4,6-dimethyl-2,4,6-tri-(4-hydroxy-phenyl)heptene-2,4,6-dimethyl-2,4,6-tri-(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]-propane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)-propane, hexa(4-(4-hydroxyphenylisopropyl)phenyl)orthoterephthalic ester, tetra(4-hydroxyphenyl)methane, tetra(4-(4-hydroxyphenylisopropyl)phenoxy)methane and 1,4-bis(4′,4″-dihydroxytriphenyl)-methyl)benzene together with 2,4-dihydroxybenzoic acid, trimesic acid, cyanuric chloride and 3,3-bis(3-methyl-4-hydroxyphenyl)-2-oxo-2,3-dihydroindole.

The quantity of branching agents optionally used amounts to 0.05 mol % to 2.5 mol %, relative again to moles of diphenols used in each case.

The branching agents may either be initially prepared with the diphenols and the chain terminators in the aqueous, alkaline phase or added prior to phosgenation in solution in an organic solvent.

All these measures for the production of polycarbonates are familiar to the person skilled in the art.

Aromatic dicarboxylic acids suitable for the production of polyester carbonates are for example phthalic acid, terephthalic acid, isophthalic acid, tert.-butylisophthalic acid, 3,3′-diphenyldicarboxylic acid, 4,4′-diphenyldicarboxylic acid, 4,4-benzophenone dicarboxylic acid, 3,4′-benzophenone dicarboxylic acid, 4,4′-diphenyl ether dicarboxylic acid, 4,4′-diphenyl sulfone dicarboxylic acid, 2,2-bis-(4-carboxyphenyl)propane, trimethyl-3-phenylindan-4,5′-dicarboxylic acid.

Of the aromatic dicarboxylic acids, it is terephthalic acid and/or isophthalic acid which are particularly preferably used.

Dicarboxylic acid derivatives are dicarboxylic acid dihalides and dicarboxylic acid dialkyl esters, in particular dicarboxylic acid dichlorides and dicarboxylic acid dimethyl esters.

Replacement of the carbonate groups by the aromatic dicarboxylic acid ester groups proceeds substantially stoichiometrically and also quantitatively, such that the molar ratio of the reaction partners is also repeated in the finished polyester carbonate. Incorporation of the aromatic dicarboxylic acid ester groups may proceed both randomly and in blocks.

Preferred methods of production of the polycarbonates to be used according to the invention, including the polyester carbonates, are the known phase boundary process and the known melt transesterification process.

In the first case, the carbonic acid derivative used is preferably phosgene, in the latter case preferably diphenyl carbonate. Catalysts, solvents, working up, reaction conditions etc. for polycarbonate production have in both cases been adequately described and are adequately known.

The polycarbonate molding compositions according to the invention may be processed into shaped articles and extrudates on the conventional processing machines in accordance with known methods and in compliance with the processing parameters conventional for polycarbonate.

### EXAMPLES

### Example 1

In a co-rotating, tightly intermeshing twin-screw extruder according to DE 199 14 143 A1 the solvents chlorobenzene and dichloromethane are removed from a stream of polycarbonate flowing at a rate of 4500 kg/h. At the point of introduction of the first and second streams the polymer stream has a temperature of 380° C. In a tightly intermeshing twin-screw extruder, 400 kg/h of polycarbonate second-quality product were melted with 30 kg/h of additives and incorporated with the main stream at a temperature of 305° C. The relative viscosity of the polycarbonate is 1,293. The pressure build-up zone is in a three-lobed configuration with an outer screw diameter of 158 mm. The color index YI of the polycarbonate is 1.6.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A continuous process for the preparation of a thermoplastic molding composition comprising introducing a first stream containing a molten polymer and at least one additive into a second extruded stream that contains a molten polymer to produce a combined stream, said first stream having a temperature be below that of the second stream, and said additive being in either liquid form, in solution or in dispersion.

2. The process of claim 1, wherein the second stream is subject to devolatilization prior to the introduction of the first stream thereto.

3. The process of claim 1, wherein the first stream is introduced to the second stream at the pressure build-up zone.

4. The process of claim 3, wherein the pressure build-up zone is cooled.

5. The thermoplastic molding composition prepared by the process of claim 1.

6. The process of claim 1, wherein the first stream comprise molten second-quality product.

7. The process according to claim 1, wherein the first stream comprise polycarbonate.

8. The process according to claim 1, wherein the second stream comprise polycarbonate.

9. The process according to claim 1, wherein the combined stream comprise polycarbonate.

10. The process of claim 2, wherein the content of residual volatiles in said second stream after devolatilization and prior to the introduction of the first stream thereto is less than 1000 ppm.

11. The process of claim 10, wherein the content is less than 500 ppm.

12. The process of claim 1, wherein the temperature of said first stream is at least 20° K below that of the second stream.

13. The process of claim 1, wherein the temperature of said first stream is at least 40° K below that of the second stream.

14. The process of claim 3, wherein the temperature at the inside wall of the extruder at the pressure build up zone is at least 40+ K lower than the temperature of the combined stream.

15. The process of claim 1, where the process is carried out in a tightly intermeshing co-rotating twin-screw extruder.

16. The process of claim 2, where the devolatilization is carried out in tightly intermeshing co-rotating twin screw extruder in a two-lobe screw configuration.

17. The process of claim 16, where the pressure build-up zone contains only conveying elements.

18. The process of claim 17, where the pressure build-up zone is in a three-lobe configuration with a smaller outer diameter than the devolatilization section.
